(19) United States
(12) Patent Application Publication
(10) Pub. No.: US 2025/0062540 A1
(43) Pub. Date: Feb. 20, 2025

(54) WIRELESS COMMUNICATION APPARATUS AND STRUCTURE

(71) Applicant: KYOCERA CORPORATION, Kyoto-shi, Kyoto (JP)

(72) Inventor: Shuichi YAMAMOTO, Yokohama-shi, Kanagawa (JP)

(73) Assignee: KYOCERA CORPORATION, Kyoto-shi, Kyoto (JP)

(21) Appl. No.: 18/723,077

(22) PCT Filed: Dec. 22, 2022
(86) PCT No.: PCT/JP2022/047492

§ 371 Date: Jun. 21, 2024

(30) Foreign Application Priority Data
Dec. 24, 2021 (JP) 2021-211726

(51) Int. Cl. H01Q 13/08; H01Q 1/24; H01Q 9/42

(52) U.S. Cl. CPC H01Q 13/08; H01Q 1/243; H01Q 9/42

(57) ABSTRACT

The wireless communication apparatus includes an antenna and a communication unit disposed inside the antenna. The antenna includes: a first conductor; a second conductor coupled to the first conductor; a third conductor coupled to the first conductor and aligned with the second conductor; a fourth conductor between the second conductor and the third conductor, the fourth conductor being located apart from the second conductor and the third conductor; a first connection conductor including one end connected to the first conductor and the other end connected to the second conductor; a second connection conductor including one end connected to the first conductor and the other end connected to the third conductor; and a power feeding conductor including one end connected to a feeding point and the other end connected to a conductor facing the feeding point among the first conductor, the second conductor, the third conductor, and the fourth conductor.

### TECHNICAL FIELD

The present disclosure relates to a wireless communication apparatus and a structure.

### BACKGROUND OF INVENTION

Known techniques include a technique for miniaturizing a communication apparatus. For example, Patent Document 1 discloses a wireless communication apparatus miniaturized by incorporating an antenna and a communication unit in one housing.

### CITATION LIST

### PATENT LITERATURE

Patent Document 1: JP 9-83240 A

### SUMMARY

In the present disclosure, a wireless communication apparatus includes an antenna and a communication unit disposed inside the antenna and configured to perform wireless communication with an external apparatus via the antenna. The antenna includes: a first conductor expanding in a first plane direction; a second conductor facing a first end portion, in a first direction, of the first conductor, coupled to the first conductor, and expanding in the first plane direction; a third conductor facing a second end portion, in the first direction, of the first conductor, coupled to the first conductor, and expanding in the first plane direction, the second conductor and the third conductor being aligned in the first direction; at least one fourth conductor between the second conductor and the third conductor in the first direction, the at least one fourth conductor being located apart from the second conductor and the third conductor, and expanding in the first plane direction; a first connection conductor including one end connected to the first conductor and the other end connected to the second conductor; a second connection conductor including one end connected to the first conductor and the other end connected to the third conductor; and a power feeding conductor including one end connected to a feeding point and the other end connected to a conductor facing the feeding point among the first conductor, the second conductor, the third conductor, and the at least one fourth conductor. The communication unit is disposed inside the antenna at a position where a magnetic field strength is relatively high.

In the present disclosure, a structure includes the wireless communication apparatus according to the present disclosure.

### BRIEF DESCRIPTION OF THE DRAWINGS

FIG. 1 is a view illustrating a configuration example of a wireless communication apparatus according to a first embodiment.

FIG. 2 is a view illustrating a configuration example of an upper surface conductor of an antenna according to the first embodiment.

FIG. 3 is a view illustrating a configuration example of a lower surface conductor of the antenna according to the first embodiment.

FIG. 4 is a block diagram illustrating a configuration example of a communication unit according to the first embodiment.

FIG. 5 is a view illustrating a flow of a current in the wireless communication apparatus according to the first embodiment.

FIG. 6 is a view illustrating a flow of a current in the upper surface conductor of the antenna according to the first embodiment.

FIG. 7 is a view illustrating a flow of a current in the lower surface conductor of the antenna according to the first embodiment.

FIG. 8 is a view for describing flows of magnetic fields inside the antenna according to the first embodiment.

FIG. 9 is a view illustrating a simulation result of a magnetic field strength inside the antenna according to the first embodiment.

FIG. 10 is a view for describing a method of disposing a communication unit according to a first comparative example.

FIG. 11 is a view illustrating flows of magnetic fields inside an antenna according to the first comparative example.

FIG. 12 is a graph for describing radiation efficiency of the antenna according to the first comparative example.

FIG. 13 is a view for describing a method of disposing a communication unit according to a second comparative example.

FIG. 14 is a view illustrating a flow of a magnetic field inside an antenna according to the second comparative example.

FIG. 15 is a graph for describing radiation efficiency of the antenna according to the second comparative example.

FIG. 16 is a view for describing a method of disposing the communication unit according to the first embodiment.

FIG. 17 is a view illustrating flows of magnetic fields inside the antenna according to the first embodiment.

FIG. 18 is a graph for describing radiation efficiency of the antenna according to the first embodiment.

FIG. 19 is a graph for describing radiation efficiency of the antenna according to the first embodiment.

FIG. 20 is a view for describing an orientation for disposing the communication unit according to the first embodiment.

FIG. 21 is a graph for describing the orientation for disposing the communication unit and the radiation efficiency of the antenna according to the first embodiment.

FIG. 22 is a view illustrating a configuration example of a wireless communication apparatus according to a second embodiment.

FIG. 23 is a view illustrating a configuration example of an upper surface conductor of an antenna according to the second embodiment.

FIG. 24 is a view for describing radiation efficiency of the antenna according to the second embodiment.

FIG. 25 is a view illustrating a method of disposing a communication unit at a lower surface conductor of the antenna according to the second embodiment.

FIG. 26 is a view illustrating a configuration example of a lower surface conductor according to a variation of the second embodiment.

### DESCRIPTION OF EMBODIMENTS

In the following, embodiments of the present invention will be described in detail with reference to the accompanying drawings. Note that the present invention is not limited by these embodiments and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X axis in a horizontal plane is defined as an X axis direction, a direction parallel to a Y axis orthogonal to the X axis in the horizontal plane is defined as a Y axis direction, and a direction parallel to a Z axis orthogonal to the horizontal plane is defined as a Z axis direction. A plane including the X axis and the Y axis is appropriately referred to as an X-Y plane. A plane including the X axis and the Z axis is appropriately referred to as an X-Z plane. A plane including the Y axis and the Z axis is appropriately referred to as a Y-Z plane. The X-Y plane is parallel to the horizontal plane. The X-Y plane, the X-Z plane, and the Y-Z plane are orthogonal to each other.

### First Embodiment

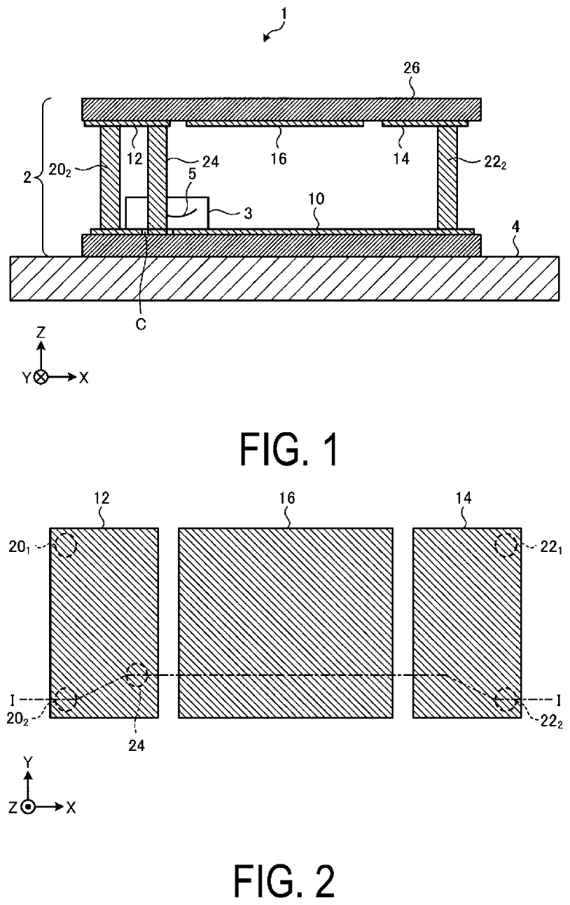

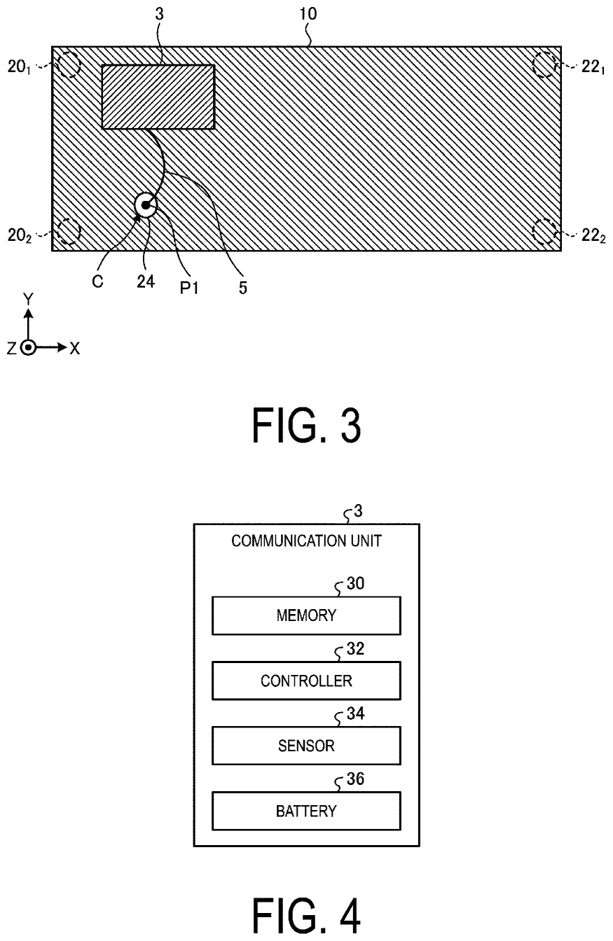

A configuration example of a wireless communication apparatus according to a first embodiment will be described with reference to FIGS. 1, 2, and 3. FIG. 1 is a view illustrating the configuration example of the wireless communication apparatus according to the first embodiment. FIG. 2 is a view illustrating a configuration example of an upper surface conductor of an antenna according to the first embodiment. FIG. 3 is a view illustrating a configuration example of a lower surface conductor of the antenna according to the first embodiment. FIG. 1 is a cross-sectional view taken along line I-I in FIG. 2.

As illustrated in FIGS. 1 to 3, a wireless communication apparatus 1 includes an antenna 2 and a communication unit 3.

The antenna 2 includes a first conductor 10, a second conductor 12, a third conductor 14, a fourth conductor 16, a first connection conductor 20₁, a first connection conductor 20₂, a second connection conductor 22₁, a second connection conductor 22₂, a power feeding conductor 24, and a housing 26. The first conductor 10, the second conductor 12, the third conductor 14, the fourth conductor 16, the first connection conductor 20₁, the first connection conductor 20₂, the second connection conductor 22₁, the second connection conductor 22₂, and the power feeding conductor 24 are accommodated in the housing 26. The first connection conductor 20₁and the first connection conductor 20₂ may be collectively referred to as a first connection conductor 20. The second connection conductor 22₁ and the second connection conductor 22₂ may be collectively referred to as a second connection conductor 22. The antenna 2 is mounted at a metal member 4, for example, on a side on which the first conductor 10 is provided. The antenna 2 need not be mounted at the metal member 4 on the side on which the first conductor 10 is provided. The metal member 4 is a type of conductive article.

The antenna 2 can emit a circularly polarized wave. The antenna 2 exhibits an artificial magnetic conductor character with respect to an electromagnetic wave with a predetermined frequency incident on the X-Y plane of the antenna 2 from the positive direction of the Z axis. In the present disclosure, the artificial magnetic conductor character means a character of a plane where the phase difference between an incident wave and a reflected wave becomes 0 degree. On the plane having the artificial magnetic conductor character, the phase difference between the incident wave and reflected wave in the frequency band ranges from −90 degrees to +90 degrees.

The first conductor 10 is a conductor expanding on the X-Y plane. The X-Y plane may also be referred to as a first plane. The X axis direction may be referred to as a first direction, and the Y axis direction may be referred to as a second direction. The first conductor 10 may be referred to as a lower surface conductor of the antenna 2. The first conductor 10 is formed in, for example, a substantially rectangular shape, but the present disclosure is not limited thereto. In the present embodiment, the first conductor 10 has a rectangular shape in which the length in the X axis direction is longer than the length in the Y axis direction. The width of the first conductor 10 in the X axis direction is longer than the widths of the second conductor 12, the third conductor 14, and the fourth conductor 16.

The second conductor 12, the third conductor 14, and the fourth conductor 16 are located away from the first conductor 10 in the Z axis direction. The second conductor 12, the third conductor 14, and the fourth conductor 16 face the first conductor 10. The second conductor 12, the third conductor 14, and the fourth conductor 16 may be referred to as an upper surface conductor of the antenna 2. The first conductor 10, the second conductor 12, the third conductor 14, and the fourth conductor 16 can have the same width in the Y axis direction. The second conductor 12 and the third conductor 14 can have the same width in the X axis direction. The width of the fourth conductor 16 in the X axis direction is larger than the widths of the second conductor 12 and the third conductor 14 in the X axis direction.

The second conductor 12 faces a first end portion, in the X axis direction, of the first conductor 10. The first end portion is an end portion of the first conductor 10 in the negative direction of the X axis. The second conductor 12 is formed in, for example, a substantially rectangular shape, but the present disclosure is not limited thereto.

The third conductor 14 faces a second end portion, in the X axis direction, of the first conductor 10. The second end portion is an end portion of the first conductor 10 in the positive direction of the X axis. The third conductor 14 is formed in, for example, a substantially rectangular shape, but the present disclosure is not limited thereto. The third conductor 14 and the second conductor 12 are aligned along the X axis direction.

The fourth conductor 16 is located between the second conductor 12 and the third conductor 14. The fourth conductor 16, the second conductor 12, and the third conductor 14 are aligned along the X axis direction. The fourth conductor 16 is not in contact with the second conductor 12 or the third conductor 14. That is, a gap is formed between the second conductor 12 and the fourth conductor 16 and between the third conductor 14 and the fourth conductor 16. The fourth conductor 16 faces the first conductor 10 between the second conductor 12 and the third conductor 14. The fourth conductor 16 is formed in, for example, a substantially rectangular shape, but the present disclosure is not limited thereto. A plurality of the fourth conductors 16 may be located between the second conductor 12 and the third conductor 14. When the plurality of fourth conductors 16 are located, the plurality of fourth conductors 16 are not in contact with each other. When the plurality of fourth conductors 16 are located, gaps are formed between the respective fourth conductors 16, and the fourth conductors 16 are aligned along the X axis direction. In other words, at least one fourth conductor 16 is located between the second conductor 12 and the third conductor 14.

The second conductor 12 and the fourth conductor 16 are capacitively coupled via a gap. The third conductor 14 and the fourth conductor 16 are capacitively coupled via a gap. When the plurality of fourth conductors 16 are located between the second conductor 12 and the third conductor 14, the fourth conductors 16 are capacitively coupled to each other via gaps.

The first connection conductor 20₁ and the first connection conductor 20₂ connect the first conductor 10 and the second conductor 12. The first connection conductor 20₁ and the first connection conductor 20₂ are, for example, columnar bodies extending in the Z axis direction. The first connection conductor 20₁ and the first connection conductor 20₂ are aligned along the Y axis direction.

The second connection conductor 22₁ and the second connection conductor 22₂ connect the first conductor 10 and the third conductor 14. The second connection conductor 22₁ and the second connection conductor 22₂ are, for example, columnar bodies extending in the Z axis direction. The second connection conductor 22₁ and the second connection conductor 22₂ are aligned along the Y axis direction.

One end of the power feeding conductor 24 is connected to a feeding point P1, and the other end thereof is connected to the second conductor 12. In the present embodiment, the feeding point P1 is provided in the vicinity of the first connection conductor 20₂ at the first conductor 10. The feeding point PI may be provided at the first conductor 10 in the vicinity of the first connection conductor 20₁, the second connection conductor 22₁, or the second connection conductor 22₂. The power feeding conductor 24 is, for example, a columnar body extending in the Z axis direction. As illustrated in FIG. 3, a clearance C is provided between the feeding point P1 and the first conductor 10. That is, the feeding point P1 is provided at the first conductor 10 with a gap therebetween. Since the clearance C is provided between the feeding point P1 and the first conductor 10, the power feeding conductor 24 and the first conductor 10 are not connected to each other. One end of the power feeding conductor 24 may be connected to the feeding point P1 and the other end thereof may be connected to the third conductor 14. One end of the power feeding conductor 24 may be connected to the feeding point PI and the other end thereof may be connected to the fourth conductor 16. That is, one end of the power feeding conductor 24 may be connected to the feeding point P1, and the other end thereof may be connected to any of the second conductor 12, the third conductor 14, and the fourth conductor 16 facing the feeding point P1.

The communication unit 3 is disposed inside the antenna 2. The communication unit 3 is disposed at the first conductor 10. The communication unit 3 is mounted at, for example, a mounting portion (not illustrated) provided at the first conductor 10. The communication unit 3 may be bonded to the first conductor 10 with, for example, a double-sided tape or an adhesive. The communication unit 3 is shielded by a metal cap or the like. The communication unit 3 is formed in, for example, a rectangular parallelepiped shape. In the example illustrated in FIG. 3, the length of the communication unit 3 in the Y axis direction is shorter than the length thereof in the X axis direction. In the present embodiment, the communication unit 3 is described as being formed in a rectangular parallelepiped shape, but the present disclosure is not limited thereto. The communication unit 3 may be formed in a cube shape or may be formed in a columnar shape. For example, one end of a feeding line 5 such as a cable is connected to the communication unit 3. The other end of the feeding line 5 is connected to the feeding point P1. That is, the communication unit 3 is connected to the feeding point PI via the feeding line 5. For example, when a radio wave is transmitted, power (signal) is fed from the communication unit 3 to the second conductor 12 via the feeding point P1. For example, when a radio wave is received, power (signal) is fed from the second conductor 12 to the communication unit 3 via the feeding point P1. The communication unit 3 and the feeding point PI may be connected by a feeding pattern extending from the feeding point PI to the communication unit 3.

A configuration example of the communication unit according to the first embodiment will be described with reference to FIG. 4. FIG. 4 is a block diagram illustrating the configuration example of the communication unit according to the first embodiment.

As illustrated in FIG. 4, the communication unit 3 includes a memory 30, a controller 32, a sensor 34, and a battery 36.

The memory 30 can include, for example, a semiconductor memory. The memory 30 can function as a work memory for the controller 32. The controller 32 can include the memory 30. The memory 30 stores programs describing processing contents for implementing the functions of the wireless communication apparatus 1, information used in the wireless communication apparatus 1, and the like.

For example, the controller 32 can include a processor. The controller 32 may include one or more processors. The processor may include a general-purpose processor that reads a specific program to execute a specific function, and a dedicated processor dedicated to specific processing. The dedicated processor may include an application-specific IC. The application-specific IC is also referred to as an Application Specific Integrated Circuit (ASIC). The processor may include a programmable logic device. The programmable logic device is also referred to as a Programmable Logic Device (PLD). The PLD may include a Field-Programmable Gate Array (FPGA). The controller 32 may be any of a System-on-a-Chip (SoC) and a System In a Package (SiP) in which one or a plurality of processors cooperate. The controller 32 may store, in the memory 30, various types of information, programs or the like for causing the components of the wireless communication apparatus 1 to operate.

The controller 32 can generate a transmission signal to be transmitted from the wireless communication apparatus 1. The controller 32 may acquire measurement data from the sensor 34, for example. The controller 32 may generate a transmission signal based on the measurement data. The controller 32 may transmit a baseband signal to the antenna 2.

The sensor 34 includes various sensors. Examples of the sensor 34 may include a velocity sensor, a vibration sensor, an acceleration sensor, a gyroscopic sensor, a rotation angle sensor, an angular velocity sensor, a geomagnetic sensor, a magnet sensor, a temperature sensor, a humidity sensor, an air pressure sensor, an optical sensor, an illuminance sensor, a UV sensor, a gas sensor, a gas concentration sensor, an atmosphere sensor, a level sensor, an odor sensor, a pressure sensor, a pneumatic sensor, a contact sensor, a wind sensor, an infrared sensor, a motion sensor, a displacement sensor, an image sensor, a weight sensor, a smoke sensor, a leakage sensor, a vital sensor, a battery level sensor, an ultrasound sensor, and the like. The sensor 34 may include a Global Navigation Satellite System (GNSS) sensor acquiring current position information of the wireless communication apparatus 1.

The battery 36 supplies power to the wireless communication apparatus 1. The battery 36 can supply power to at least one selected from the group consisting of the memory 30, the controller 32, and the sensor 34. The battery 36 can include a primary battery and/or a secondary battery. The negative electrode of the battery 36 can be electrically connected to a ground terminal of a circuit substrate (not illustrated).

A method of disposing the communication unit according to the first embodiment will be described.

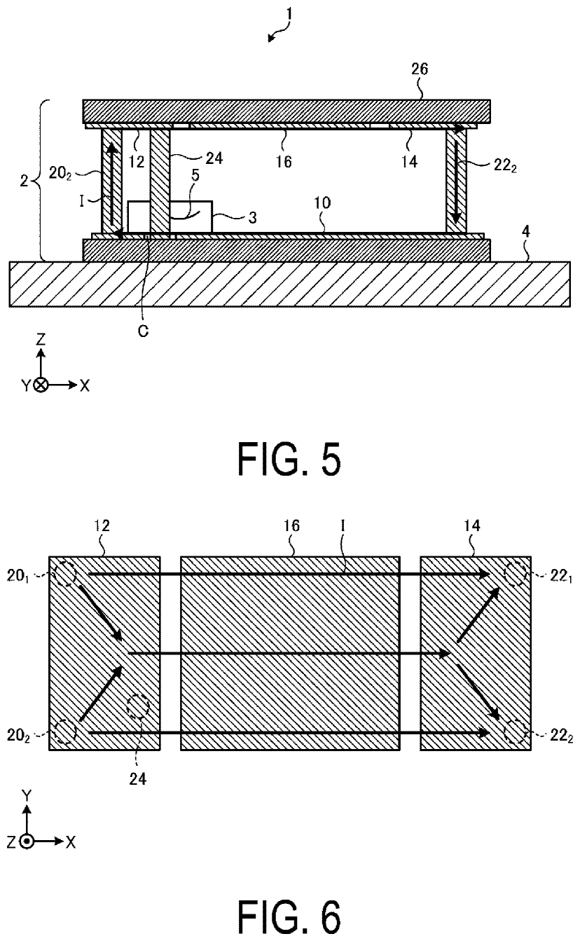

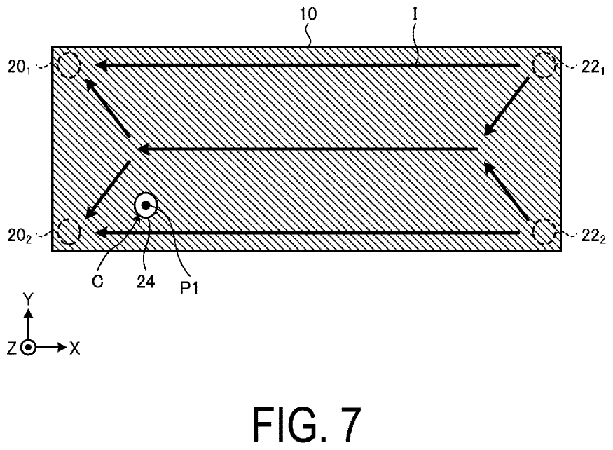

FIGS. 5, 6, and 7 are views for describing a flow of a current in the antenna 2 according to the first embodiment. FIG. 5 is a view illustrating a flow of a current in the wireless communication apparatus according to the first embodiment. FIG. 5 illustrates a cross section at the same position as line I-I in FIG. 2. FIG. 6 is a view illustrating a flow of a current in the upper surface conductor of the antenna according to the first embodiment. FIG. 7 is a view illustrating a flow of a current in the lower surface conductor of the antenna according to the first embodiment.

As illustrated in FIGS. 5 to 7, a current I flows so as to circulate through the first conductor 10, the first connection conductors 20, the second conductor 12, the fourth conductor 16, the third conductor 14, the second connection conductors 22, and the first conductor 10 in this order.

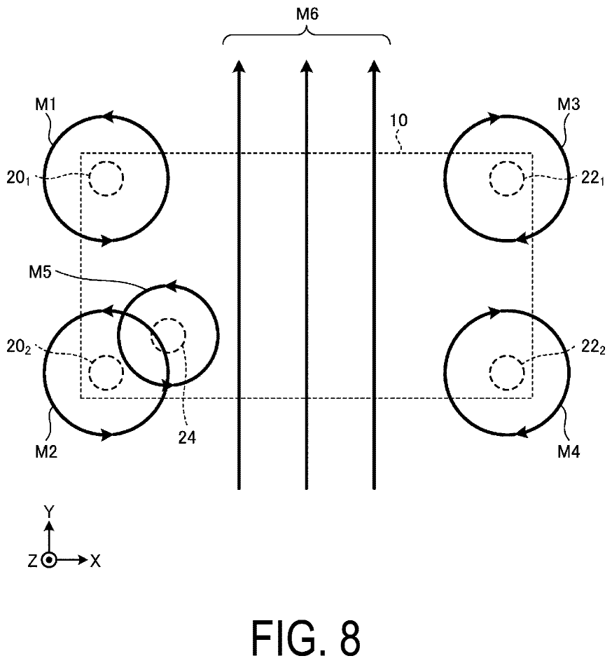

FIG. 8 is a view for describing flows of magnetic fields inside the antenna 2 according to the first embodiment. FIG. 8 schematically illustrates flows of magnetic fields between the first conductor 10 and the second conductor 12, the third conductor 14, and the fourth conductor 16.

A magnetic field MI is a magnetic field generated by a current flowing through the first connection conductor 20₁. A magnetic field M2 is a magnetic field generated by a current flowing through the first connection conductor 20₂. Since the directions of the currents flowing through the first connection conductor 20₁ and the first connection conductor 20₂ are the same, the directions of the magnetic field MI and the magnetic field M2 are the same. The magnetic field Ml and the magnetic field M2 are counterclockwise circular magnetic fields surrounding the first connection conductor 20₁ and the first connection conductor 20₂, respectively, when viewed from directly above the X-Y plane.

A magnetic field M3 is a magnetic field generated by a current flowing through the second connection conductor 22₁. A magnetic field M4 is a magnetic field generated by a current flowing through the second connection conductor 22₂. Since the directions of the currents flowing through the second connection conductor 22₁ and the second connection conductor 22₂ are the same, the directions of the magnetic field M3 and the magnetic field M4 are the same. The magnetic field M3 and the magnetic field M4 are clockwise circular magnetic fields surrounding the second connection conductor 22₁ and the second connection conductor 22₂, respectively, when viewed from directly above the X-Y plane.

Since the directions of the currents flowing through the first connection conductors 20 are opposite to the directions of the currents flowing through the second connection conductors 22, the directions of the magnetic field MI and the magnetic field M2 are opposite to the directions of the magnetic field M3 and the magnetic field M4.

A magnetic field M5 is a magnetic field generated by a current flowing through the power feeding conductor 24. The magnetic field M5 is a counterclockwise circular magnetic field surrounding the power feeding conductor 24 when viewed from directly above the X-Y plane. Since the direction of the current flowing through the power feeding conductor 24 is the same as the directions of the currents flowing through the first connection conductors 20, the direction of the magnetic field M5 is the same as the directions of the magnetic field MI and the magnetic field M2.

A magnetic field M6 is a magnetic field near the center in the X axis direction, which is generated by current flowing through the first conductor 10, the second conductor 12, the third conductor 14, and the fourth conductor 16. The magnetic field M6 is a magnetic field parallel to the Y axis direction when viewed from directly above the X-Y plane. In the example illustrated in FIG. 8, the magnetic field M6 is a magnetic field flowing from the −Y axis direction to the +Y axis direction. The direction of the current flowing through the first conductor 10 is opposite to the direction of the current flowing through the second conductor 12, the third conductor 14, and the fourth conductor 16. Thus, the direction of the magnetic field generated by the current flowing through the first conductor 10 is opposite to the direction of the magnetic field generated by the current flowing through the second conductor 12, the third conductor 14, and the fourth conductor 16. The directions of the magnetic fields between the first conductor 10 and the second conductor 12, the third conductor 14, and the fourth conductor 16 are the same such as the +Y axis direction or the-Y axis direction. The magnetic field M6 is the sum of the magnetic field generated by the current flowing through the first conductor 10, the magnetic field generated by the current flowing through the second conductor 12, the third conductor 14, and the fourth conductor 16, and the magnetic fields generated by the currents flowing through the first connection conductors 20 and the second connection conductors 22. Each of the directions of the magnetic field MI to the magnetic field M4 between the first conductor 10 and the second conductor 12, the third conductor 14, and the fourth conductor 16 is the +Y axis direction. In the present embodiment, since the connection conductors are spaced apart from each other, the influence of the magnetic field MI to the magnetic field M4 on the magnetic field M6 is relatively small.

The directions of the magnetic field MI and the magnetic field M2 are opposite between the first connection conductor 20₁ and the first connection conductor 20₂. Thus, the magnetic field MI and the magnetic field M2 cancel each other between the first connection conductor 20₁ and the first connection conductor 20₂, and the magnetic field becomes weak.

The directions of the magnetic field M3 and the magnetic field M4 are opposite between the second connection conductor 22₁ and the second connection conductor 22₂. Thus, the magnetic field M3 and the magnetic field M4 cancel each other between the second connection conductor 22₁ and the second connection conductor 22₂, and the magnetic field becomes weak.

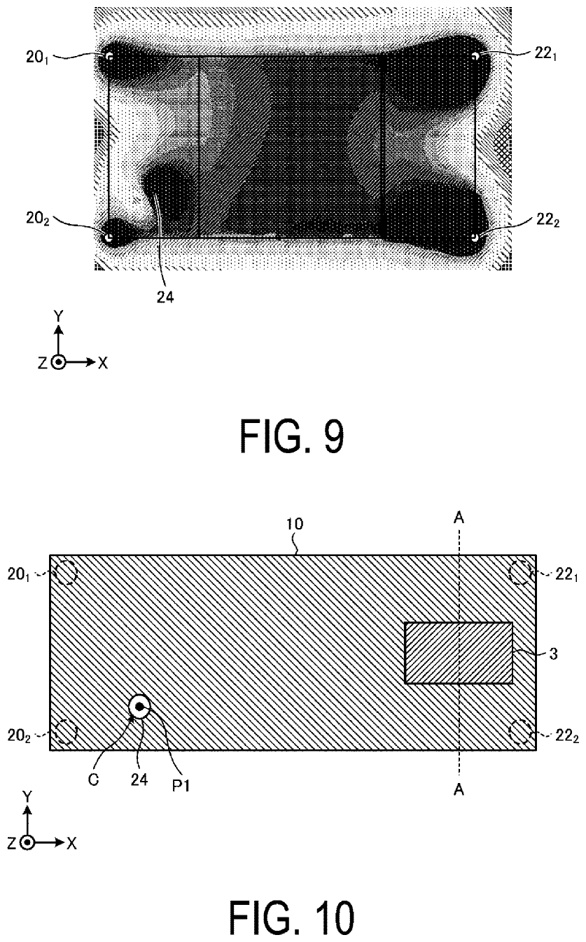

FIG. 9 is a view illustrating a simulation result of a magnetic field strength inside the antenna 2 according to the first embodiment. In FIG. 9, the color is darker as a region has a higher magnetic field strength, and the color is lighter as a region has a lower magnetic field strength. As illustrated in FIG. 9, inside the antenna 2, regions around the first connection conductor 20₁, the first connection conductor 20₂, the second connection conductor 22₁, the second connection conductor 22₂, and the power feeding conductor 24 are regions having the highest magnetic field strengths. Inside the antenna 2, a region near the center in the longitudinal direction is a region having a relatively high magnetic field strength. Inside the antenna 2, a region between the first connection conductor 20₁ and the first connection conductor 20₂ and a region between the second connection conductor 22₁ and the second connection conductor 22₂ are regions having the lowest magnetic field strengths.

As illustrated in FIGS. 8 and 9, the magnetic fields have different flows and strengths at different locations inside the antenna 2. In the present embodiment, the location where the communication unit 3 is disposed inside the antenna 2 is determined based on the flow of the magnetic field and/or the magnetic field strength. In the present embodiment, the communication unit 3 is disposed at a position where the magnetic field strength is relatively high inside the antenna 2. Specifically, in the present embodiment, the communication unit 3 is disposed in the vicinity of the first connection conductors 20 or the second connection conductors 22 where the magnetic field strength is relatively high.

Method of Disposing Communication Unit According to Comparative Example Before describing a method of disposing the communication unit 3 according to the first embodiment, a method of disposing a communication unit 3 according to a comparative example will be described.

### First Comparative Example

FIG. 10 is a view for describing a method of disposing a communication unit 3 according to a first comparative example. FIG. 10 is a view of a first conductor 10 when viewed from the above. As illustrated in FIG. 10, for example, the communication unit 3 is disposed between a second connection conductor 22₁ and a second connection conductor 22₂ at the first conductor 10. In the example illustrated in FIG. 10, the communication unit 3 is disposed between the second connection conductor 22₁ and the second connection conductor 22₂ at the first conductor 10 such that the longitudinal direction of the communication unit 3 and the longitudinal direction of the first conductor 10 are along each other.

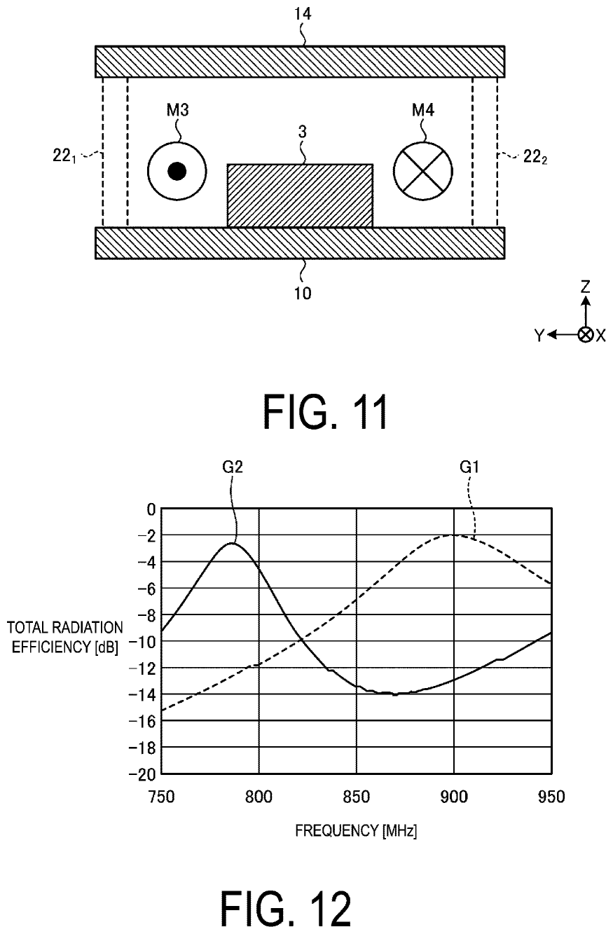

FIG. 11 is a view illustrating flows of magnetic fields inside an antenna 2 according to the first comparative example. FIG. 11 is a cross-sectional view taken along line A-A in FIG. 10.

As illustrated in FIG. 11, the communication unit 3 is disposed between the second connection conductor 22₁ and the second connection conductor 22₂. A magnetic field M3 is generated around the second connection conductor 22₁. A magnetic field M4 is disposed around the second connection conductor 22₂. Since the communication unit 3 is disposed in a region where the magnetic field is weak, the magnetic field hardly flows in a space between a third conductor 14 and the communication unit 3. That is, when the communication unit 3 is disposed in a region where the magnetic field is weakened because the direction of the magnetic field M3 and the direction of the magnetic field M4 are opposite to each other, the magnetic fields do not weaken each other in the region. Thus, the magnetic field becomes stronger compared to a case in which the communication unit 3 is not disposed.

The radiation efficiency of the antenna according to the first comparative example will be described with reference to FIG. 12. FIG. 12 is a graph for describing the radiation efficiency of the antenna according to the first comparative example.

In FIG. 12, the horizontal axis represents the frequency [MHz (megahertz)] and the vertical axis represents the total radiation efficiency [dB (decibel)]. A graph G1 indicates the total radiation efficiency of the antenna 2 when the communication unit 3 is not disposed. A graph G2 indicates the total radiation efficiency of the antenna 2 when the communication unit 3 is disposed between the second connection conductor 22₁ and the second connection conductor 22₂ at the first conductor 10.

In the example shown in FIG. 12, as indicated by the graph G1, the resonant frequency of the antenna 2 is approximately 900 MHz. As indicated by the graph G2, when the communication unit 3 is disposed between the second connection conductor 22₁ and the second connection conductor 22₂, the resonant frequency of the antenna 2 is 800 MHz or less. When the communication unit 3 is disposed between the second connection conductor 221 and the second connection conductor 22₂ at the first conductor 10, the inductance component of the antenna 2 increases, which shifts the resonant frequency toward a lower frequency. That is, when the communication unit 3 is disposed between the second connection conductor 22₁ and the second connection conductor 22₂ at the first conductor 10, the radiation characteristic changes from that of the antenna 2 when the communication unit 3 is not disposed at the first conductor 10.

### Second Comparative Example

FIG. 13 is a view for describing a method of disposing a communication unit 3 according to a second comparative example. FIG. 13 is a view of a first conductor 10 when viewed from the above. As illustrated in FIG. 13, for example, the communication unit 3 is disposed at a center portion of the first conductor 10. In the example illustrated in FIG. 13, the communication unit 3 is disposed at the center portion of the first conductor 10 such that the longitudinal direction of the communication unit 3 and the longitudinal direction of the first conductor 10 are along each other.

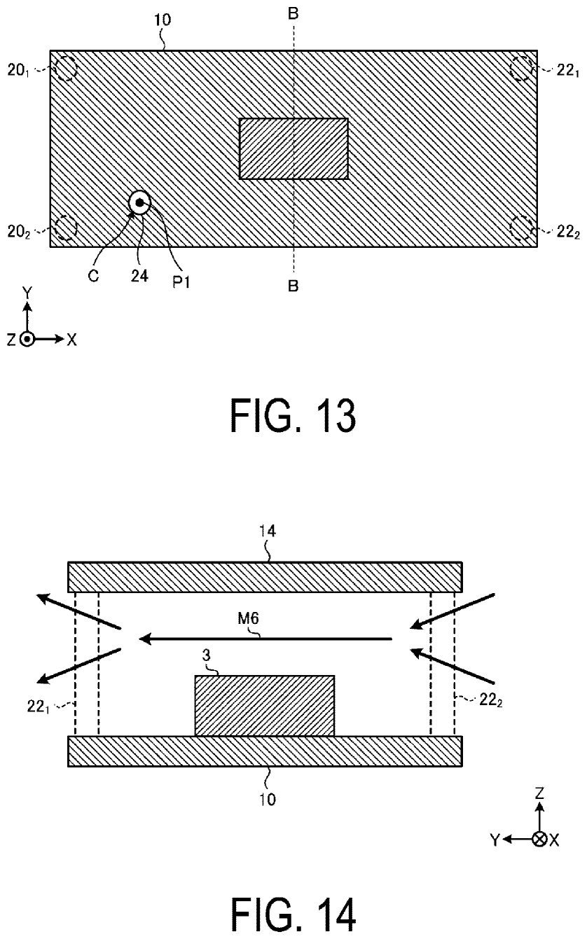

FIG. 14 is a view illustrating a flow of a magnetic field inside an antenna 2 according to the second comparative example. FIG. 14 is a cross-sectional view taken along line B-B in FIG. 13.

As illustrated in FIG. 14, the communication unit 3 is disposed at the center portion of the first conductor 10. A magnetic field M6 is generated at the center portion of the first conductor 10. A part of the magnetic field M6 is blocked by the communication unit 3, and the rest thereof flows through a space between a third conductor 14 and the communication unit 3. That is, since the communication unit 3 is disposed at the center portion of the first conductor 10, the magnetic field at the center portion of the first conductor 10 becomes weaker than when the communication unit 3 is not disposed.

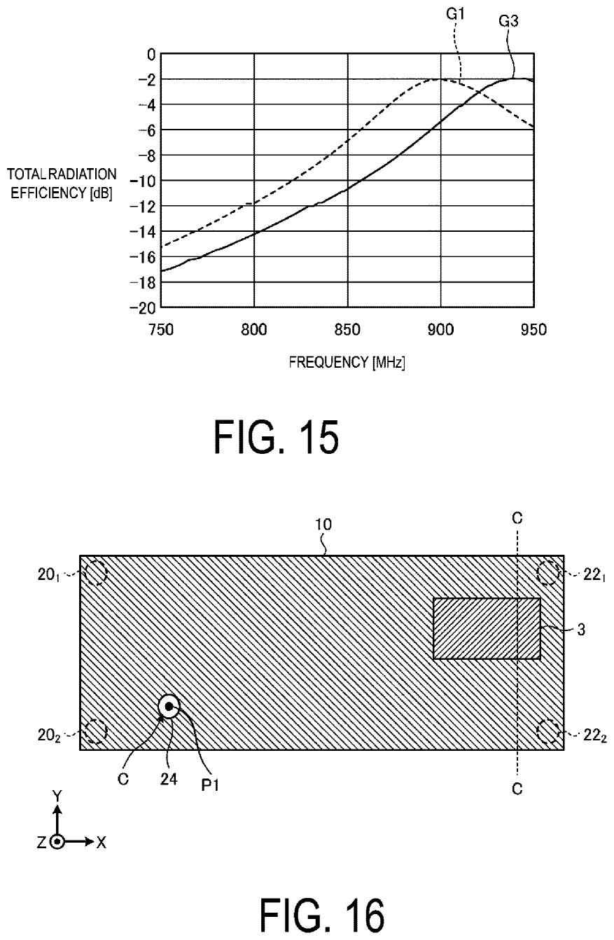

The radiation efficiency of the antenna according to the second comparative example will be described with reference to FIG. 15. FIG. 15 is a graph for describing the radiation efficiency of the antenna according to the second comparative example.

In FIG. 15, the horizontal axis represents the frequency [MHz] and the vertical axis represents the total radiation efficiency [dB]. A graph G1 indicates the total radiation efficiency of the antenna 2 when the communication unit 3 is not disposed. A graph G3 indicates the total radiation efficiency of the antenna 2 when the communication unit 3 is disposed at the center portion of the first conductor 10 such that the longitudinal direction of the communication unit 3 and the longitudinal direction of the first conductor 10 are along each other.

In the example shown in FIG. 15, as indicated by the graph G1, the resonant frequency of the antenna 2 is approximately 900 MHz. As indicated by the graph G3, the resonant frequency of the antenna 2 when the communication unit 3 is disposed at the center portion of the first conductor 10 is 900 MHz or more. When the communication unit 3 is disposed at the center portion of the first conductor 10, the inductance component of the antenna 2 decreases, which shifts the resonant frequency toward a higher frequency. That is, when the communication unit 3 is disposed at the center portion of the first conductor 10, the radiation characteristic changes from that of the antenna 2 when the communication unit 3 is not disposed at the first conductor 10.

### Method of Disposing Communication Unit According to First Embodiment

FIG. 16 is a view for describing the method of disposing the communication unit 3 according to the first embodiment. FIG. 16 is a view of the first conductor 10 when viewed from the above. As illustrated in FIG. 16, for example, the communication unit 3 is disposed in the vicinity of the second connection conductor 22₁ at the first conductor 10. In the example illustrated in FIG. 16, the communication unit 3 is disposed in the vicinity of the second connection conductor 22₁ at the first conductor 10 such that the longitudinal direction of the communication unit 3 and the longitudinal direction of the first conductor 10 are along each other.

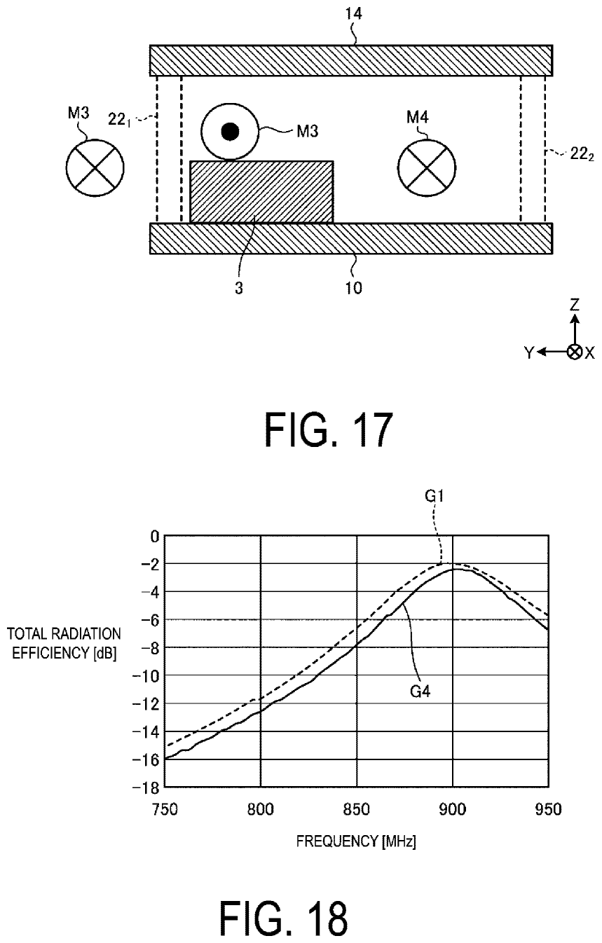

FIG. 17 is a view illustrating flows of magnetic fields inside the antenna 2 according to the first embodiment. FIG. 17 is a cross-sectional view taken along line C-C in FIG. 16.

As illustrated in FIG. 17, the communication unit 3 is disposed in the vicinity of the second connection conductor 22₁. A magnetic field M3 is generated around the second connection conductor 22₁. Since the communication unit 3 is disposed in the vicinity of the second connection conductor 22₁, the strength of the magnetic field M3 is high around the communication unit 3. Thus, the magnetic field M3 flows through a space between the communication unit 3 and the third conductor 14 without being blocked by the communication unit 3. Thus, the magnetic field M3 generated around the second connection conductor 22₁ and a magnetic field M4 generated around the second connection conductor 22₂ cancel each other.

The radiation efficiency of the antenna according to the first embodiment will be described with reference to FIG. 18. FIG. 18 is a graph for describing the radiation efficiency of the antenna according to the first embodiment.

In FIG. 18, the horizontal axis represents the frequency [MHz] and the vertical axis represents the total radiation efficiency [dB]. A graph G1 indicates the total radiation efficiency of the antenna 2 when the communication unit 3 is not disposed. A graph G4 indicates the total radiation efficiency of the antenna 2 when the communication unit 3 is disposed in the vicinity of the second connection conductor 22₁ at the first conductor 10.

As shown in FIG. 18, the resonant frequency of the graph G1 and the resonant frequency of the graph G4 are 900 MHz and substantially the same. The total radiation efficiency at the resonant frequency of the graph G1 is approximately −2 dB and is good. The total radiation efficiency at the resonant frequency of the graph G4 is slightly lower than −2 dB but is good. The graph G4 indicates a characteristic close to that of the graph Gl in the band from 750 MHz to 950 MHz. That is, it can be said that the radiation characteristic of the antenna 2 in which the communication unit 3 is disposed in the vicinity of the second connection conductor 22₁ is substantially the same as the radiation characteristic of the antenna 2 in which the communication unit 3 is not disposed. That is, when the communication unit 3 is disposed in the vicinity of the second connection conductor 22₁ at the first conductor 10, the antenna 2 and the communication unit 3 can be integrated without change in the characteristic of the antenna 2. Accordingly, the wireless communication apparatus 1 can be miniaturized.

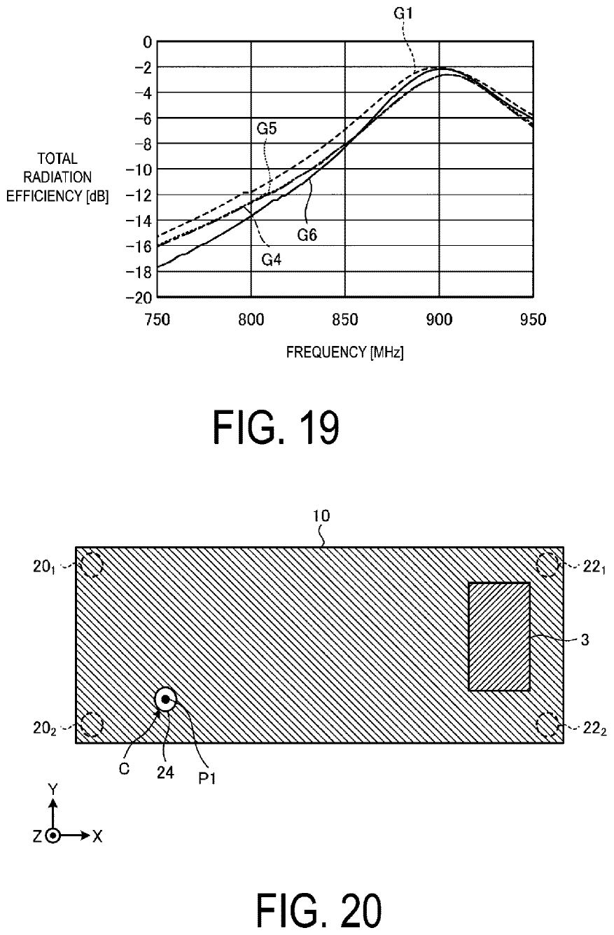

The radiation efficiency of the antenna according to the first embodiment will be described with reference to FIG. 19. FIG. 19 is a graph for describing the radiation efficiency of the antenna according to the first embodiment.

In FIG. 19, the horizontal axis represents the frequency [MHz] and the vertical axis represents the total radiation efficiency [dB]. A graph Gl indicates the radiation efficiency of the antenna 2 when the communication unit 3 is not disposed at the first conductor 10. A graph G4 indicates the radiation efficiency of the antenna 2 when the communication unit 3 is disposed in the vicinity of the second connection conductor 22₁ at the first conductor 10. A graph G5 indicates the radiation efficiency of the antenna 2 when the communication unit 3 is disposed in the vicinity of the second connection conductor 22₂ at the first conductor 10. A graph G6 indicates the radiation efficiency of the antenna 2 when the communication unit 3 is disposed in the vicinity of the first connection conductor 20₁ at the first conductor 10. In the example shown in FIG. 19, it is assumed that the communication unit 3 is disposed at the first conductor 10 such that the longitudinal direction of the communication unit 3 and the longitudinal direction of the first conductor 10 are along each other.

As shown in FIG. 19, the graph G4 and the graph G5 substantially match each other. That is, the radiation characteristic of the antenna 2 when the communication unit 3 is disposed in the vicinity of the second connection conductor 22₁ at the first conductor 10 and the radiation characteristic of the antenna 2 when the communication unit 3 is disposed in the vicinity of the second connection conductor 22₂ at the first conductor 10 substantially match each other.

In the graph G6, the radiation characteristic at the resonant frequency is approximately −2 dB. The radiation characteristic at the resonant frequency in the graph G6 substantially matches that in the graph G1. The radiation characteristic of the antenna 2 at the resonant frequency when the communication unit 3 is disposed in the vicinity of the first connection conductor 20₁ at the first conductor 10 substantially matches the radiation characteristic of the antenna 2 at the resonant frequency when the communication unit 3 is not disposed. That is, it is preferable to dispose the communication unit 3 in the vicinity of the first connection conductor 20₁ at the first conductor 10, rather than in the vicinity of the second connection conductor 22₁and the second connection conductor 22₂.

That is, as shown in FIG. 19 and the like, in the present embodiment, the communication unit 3 is disposed at the first conductor 10 in the vicinity of the first connection conductor 20₁, the second connection conductor 22₁, or the second connection conductor 22₂. Thus, the antenna 2 and the communication unit 3 can be integrated.

In the present embodiment, as illustrated in FIG. 3 and the like, since the feeding point P1 and the power feeding conductor 24 are provided in the vicinity of the first connection conductor 20₂, there is a possibility that the communication unit 3 cannot be disposed in the vicinity of the first connection conductor 20₂ due to the restriction of the arrangement space. Thus, the communication unit 3 is preferably disposed in the vicinity of any of the first connection conductor 20₁, the second connection conductor 22₁, and the second connection conductor 22₂ other than the first connection conductor 20₂ provided in the vicinity of the feeding point P1 and the power feeding conductor 24. However, when the restriction of the arrangement space is eliminated by miniaturization of the communication unit 3, and the like, the communication unit 3 may be disposed in the vicinity of the first connection conductor 20₂.

In the present embodiment, as illustrated in FIG. 3 and the like, the communication unit 3 and the feeding point PI are connected via the feeding line 5. From the viewpoint of the routing of the feeding line 5, it is preferable to dispose the communication unit 3 in the vicinity of the first connection conductor 20₁ or the first connection conductor 20₂ rather than in the vicinity of the second connection conductor 22₁ or the second connection conductor 22₂.

### Orientation for Disposing Communication Unit

Next, an orientation for disposing the communication unit 3 will be described.

FIG. 20 is a view for describing the orientation for disposing the communication unit 3 according to the first embodiment. In the example illustrated in FIG. 20, the communication unit 3 is disposed in the vicinity of the second connection conductor 22₁ at the first conductor 10 such that the longitudinal direction of the communication unit 3 is along the lateral direction of the first conductor 10.

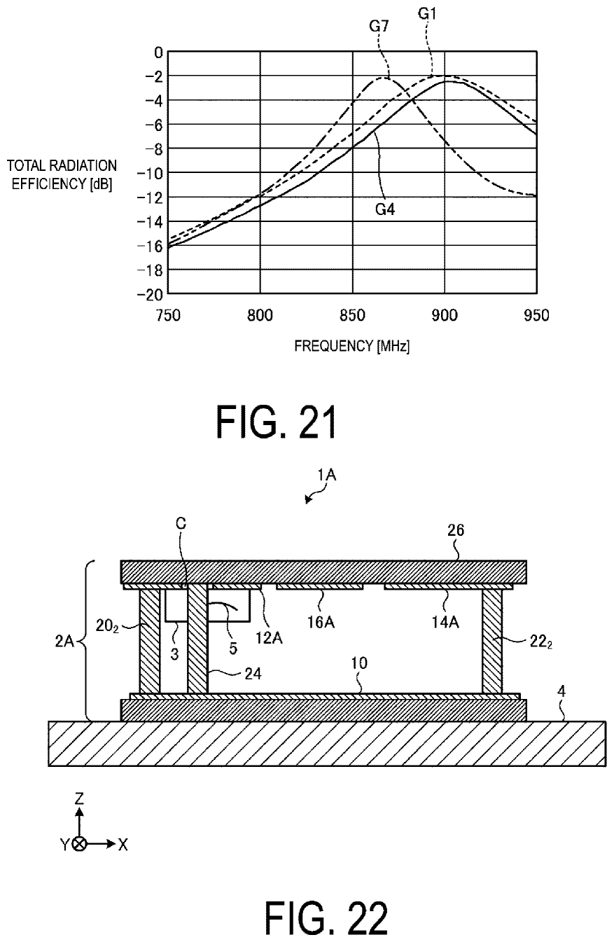

The relationship between the orientation for disposing the communication unit and the radiation efficiency of the antenna according to the first embodiment will be described with reference to FIG. 21. FIG. 21 is a graph for describing the orientation for disposing the communication unit and the radiation efficiency of the antenna according to the first embodiment.

In FIG. 21, the horizontal axis represents the frequency [MHz] and the vertical axis represents the total radiation efficiency [dB]. A graph Gl indicates the radiation efficiency of the antenna 2 when the communication unit 3 is not disposed at the first conductor 10. A graph G4 indicates the total radiation efficiency of the antenna 2 when the communication unit 3 is disposed in the vicinity of the second connection conductor 22₁ at the first conductor 10 such that the longitudinal direction of the communication unit 3 is parallel to the longitudinal direction of the first conductor 10. A graph G7 indicates the total radiation efficiency of the antenna 2 when the communication unit 3 is disposed in the vicinity of the second connection conductor 22₁ at the first conductor 10 such that the longitudinal direction of the communication unit 3 is parallel to the lateral direction of the first conductor 10.

As indicated by the graph G7, when the communication unit 3 is disposed in the vicinity of the second connection conductor 22₁ at the first conductor 10 such that the longitudinal direction of the communication unit 3 is parallel to the lateral direction of the first conductor 10, the resonant frequency of the antenna 2 is 900 MHz or less. When the communication unit 3 is disposed in the vicinity of the second connection conductor 22₁ such that the longitudinal direction of the communication unit 3 is parallel to the lateral direction of the first conductor 10, the communication unit 3 can reach a region between the second connection conductor 22¹ and the second connection conductor 22² where the magnetic field is weakened. Thus, since the magnetic field is not weakened in the region between the second connection conductor 22¹ and the second connection conductor 22², the magnetic field becomes stronger compared to the case where the communication unit 3 is not disposed. That is, when the communication unit 3 is disposed between the second connection conductor 22₁ and the second connection conductor 22² at the first conductor 10, the inductance component of the antenna 2 increases, which shifts the resonant frequency toward a lower frequency.

That is, as shown in FIG. 21, the communication unit 3 is preferably disposed in the vicinity of the second connection conductor 22₁ so as not to reach a region between the second connection conductor 22₁ and the second connection conductor 22₂ where the magnetic field is weakened. In the present embodiment, the communication unit 3 is preferably disposed such that the lateral direction of the communication unit 3 is parallel to the lateral direction of the first conductor 10.

### Second Embodiment

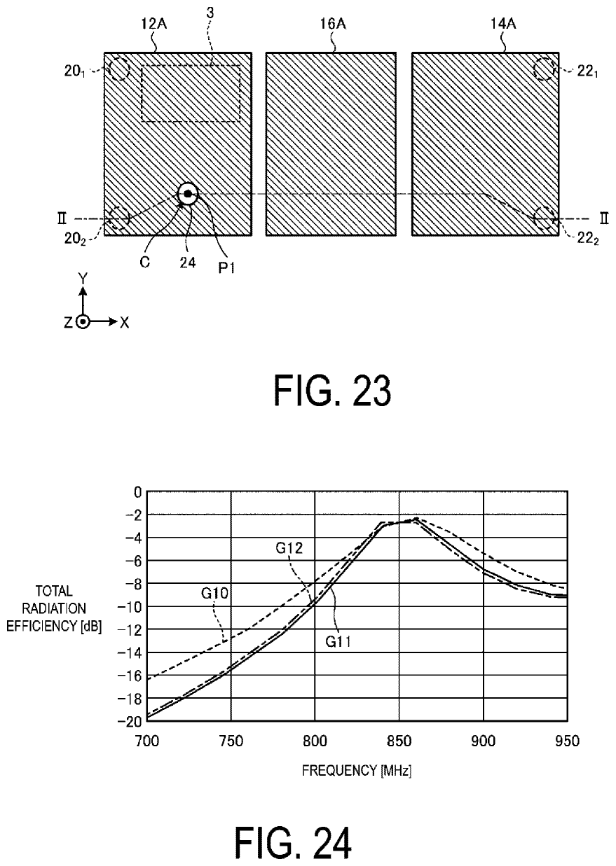

A configuration example of a wireless communication apparatus according to a second embodiment will be described with reference to FIGS. 22 and 23. FIG. 22 is a view illustrating the configuration example of the wireless communication apparatus according to the second embodiment. FIG. 23 is a view illustrating a configuration example of an upper surface conductor of an antenna according to the second embodiment. FIG. 22 is a cross-sectional view taken along line II-II in FIG. 23. Note that since the configuration of a lower surface conductor of the antenna according to the second embodiment is the same as the configuration of the first conductor 10 illustrated in FIG. 3, description thereof will be omitted.

As illustrated in FIGS. 22 and 23, a wireless communication apparatus 1A includes an antenna 2A and a communication unit 3.

The antenna 2A includes a first conductor 10, a second conductor 12A, a third conductor 14A, a fourth conductor 16A, a first connection conductor 20₁, a first connection conductor 20₂, a second connection conductor 22₁, a second connection conductor 22₂, a power feeding conductor 24, and a housing 26.

In the second embodiment, the communication unit 3 is disposed at the second conductor 12A or the third conductor 14A of the upper surface conductor inside the antenna 2A. In this point, the wireless communication apparatus 1A of the second embodiment is different from the wireless communication apparatus 1 illustrated in FIG. 1. In the example illustrated in FIGS. 22 and 23, the communication unit 3 is disposed at the second conductor 12A. Specifically, the communication unit 3 is disposed in the vicinity of the first connection conductor 20₁ at the second conductor 12A such that the longitudinal direction of the communication unit 3 is parallel to the longitudinal direction of the antenna 2A. The communication unit 3 may be disposed at the third conductor 14A.

The second conductor 12A is longer in the X axis direction than the second conductor 12 illustrated in FIG. 2. Specifically, the second conductor 12A is formed to be long in the X axis direction to such an extent that the communication unit 3 can be disposed in the vicinity of the first connection conductor 20 such that the longitudinal direction of the communication unit 3 is parallel to the longitudinal direction of the antenna 2A.

The third conductor 14A is longer in the X axis direction than the third conductor 14 illustrated in FIG. 2. Specifically, the third conductor 14A is formed to be long in the X axis direction to such an extent that the communication unit 3 can be disposed in the vicinity of the second connection conductor 22 such that the longitudinal direction of the communication unit 3 is parallel to the longitudinal direction of the antenna 2A.

The length of the second conductor 12A in the X axis direction is the same as the length of the third conductor 14A in the X axis direction.

The second conductor 12A and the third conductor 14A are formed longer than the second conductor 12 and the third conductor 14 illustrated in FIG. 2 respectively and, by this lengthened amount, the fourth conductor 16A is formed shorter in the X axis direction than the fourth conductor 16 illustrated in FIG. 2. In the example illustrated in FIGS. 22 and 23, the length of the fourth conductor 16A in the X axis direction is shorter than the lengths of the second conductor 12A and the third conductor 14A.

As illustrated in FIG. 23, in the second embodiment, a feeding point PI is provided at the second conductor 12A. A clearance C is provided between the feeding point PI and the second conductor 12A. One end of the power feeding conductor 24 is connected to the feeding point P1, and the other end thereof is connected to the first conductor 10. Since the clearance C is provided between the feeding point PI and the second conductor 12A, the power feeding conductor 24 and the second conductor 12A are not connected to each other. The feeding point PI may be provided at any of the third conductor 14A and the fourth conductor 16A with a gap therebetween. That is, in the second embodiment, one end of the power feeding conductor 24 can be connected to the feeding point PI provided at any of the second conductor 12A, the third conductor 14A, and the fourth conductor 16A with a gap therebetween, and the other end thereof can be connected to the first conductor 10 facing the feeding point P1.

The radiation efficiency of the antenna according to the second embodiment will be described with reference to FIG. 24. FIG. 24 is a graph for describing the radiation efficiency of the antenna according to the second embodiment.

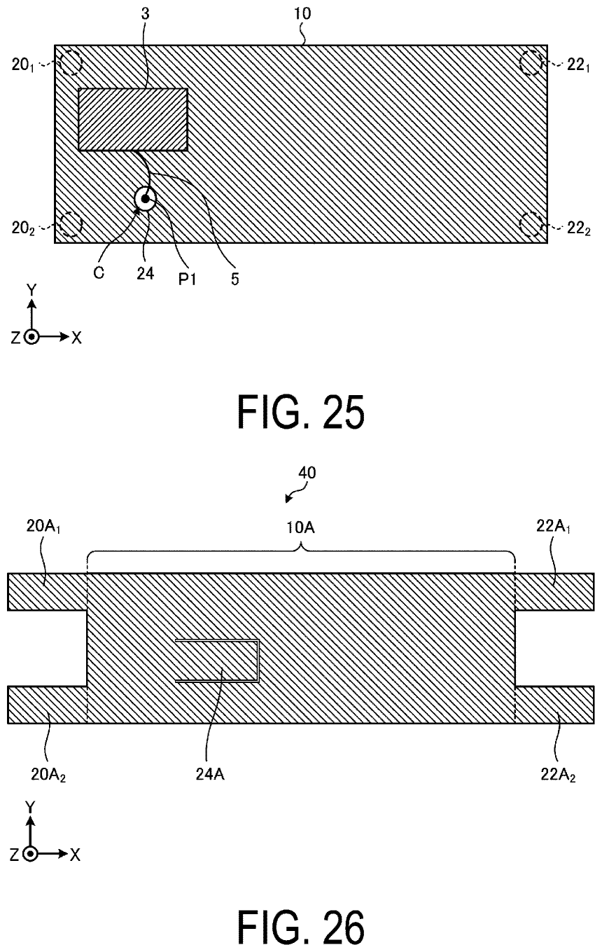

In FIG. 24, the horizontal axis represents the frequency [MHz] and the vertical axis represents the total radiation efficiency [dB]. A graph G10 indicates the total radiation efficiency of the antenna 2A when the communication unit 3 is not disposed. A graph G11 indicates the radiation efficiency of the antenna 2A when the communication unit 3 is disposed in the vicinity of the first connection conductor 20₁ at the first conductor 10 such that the longitudinal direction of the communication unit 3 is parallel to the longitudinal direction of the antenna 2A, as illustrated in FIG. 25. In FIG. 25, it is assumed that the feeding point PI is provided at the first conductor 10 via a clearance C. In the example illustrated in FIG. 25, one end of the feeding-point P+power feeding conductor 24 is connected to the feeding point P1, and the other end thereof is connected to the second conductor 12A facing the feeding point P1. A graph G12 indicates the radiation efficiency of the antenna 2A when the communication unit 3 is disposed in the vicinity of the first connection conductor 20₁ at the second conductor 12A such that the longitudinal direction of the communication unit 3 is parallel to the longitudinal direction of the antenna 2A.

As indicated by the graph G10, the resonant frequency of the antenna 2A when the communication unit 3 is not disposed is approximately 850 MHz. The total radiation efficiency at the resonant frequency of the graph G10 is approximately −3 dB and is good.

As indicated by the graph G11, when the communication unit 3 is disposed in the vicinity of the first connection conductor 20₁ at the first conductor 10 such that the longitudinal direction of the communication unit 3 is parallel to the longitudinal direction of the antenna 2A, the resonant frequency of the antenna 2A is approximately 850 MHz. The total radiation efficiency at the resonant frequency of the graph G11 is approximately −3 dB and is good.

As indicated by the graph G12, when the communication unit 3 is disposed in the vicinity of the first connection conductor 20₁ at the second conductor 12A such that the longitudinal direction of the communication unit 3 is parallel to the longitudinal direction of the antenna 2A, the resonant frequency of the antenna 2A is approximately 850 MHz. The total radiation efficiency at the resonant frequency of the graph G12 is approximately −3 dB and is good.

The resonant frequencies of the graph G11 and the graph G12 and the radiation characteristics at the resonant frequencies substantially match the resonant frequency of the graph G10 and the radiation characteristic at the resonant frequency. The resonant frequencies of the graph G11 and the graph G12 substantially match the resonant frequency of the graph G10. The radiation characteristics of the graph G11 and the graph G12 substantially match in the range from 700 MHz to 950 MHz. That is, the radiation characteristics in the range from 700 MHz to 950 MHz are substantially matched between the case where the communication unit 3 is disposed at the first conductor 10 and the case where the communication unit 3 is disposed at the second conductor 12A. That is, for this reason, the communication unit 3 can be disposed at any of the first conductor 10, the second conductor 12A, and the third conductor 14A in the second embodiment.

In the second embodiment, the communication unit 3 may be disposed at the second conductor 12A or may be disposed at the third conductor 14A. From the viewpoint of the routing of a feeding line 5, the communication unit 3 is preferably disposed at one of the second conductor 12A and the third conductor 14A that is closer to the feeding point P1. In the example illustrated in FIGS. 22 and 23, the communication unit 3 is preferably disposed at the second conductor 12A.

### Variation of Second Embodiment

A variation of the second embodiment of the present disclosure will be described.

The second embodiment has been described on the assumption that the communication unit 3 is mounted at the second conductor 12A or the third conductor 14A. In this case, the lower surface conductor may be made of one sheet metal or the like.

A configuration example of a lower surface conductor according to the variation of the second embodiment will be described with reference to FIG. 26. FIG. 26 is a view illustrating the configuration example of the lower surface conductor according to the variation of the second embodiment.

As illustrated in FIG. 26, a lower surface conductor 40 includes a first conductor 10A, a first connection conductor 20A₁, a first connection conductor 20A₂, a second connection conductor 22A₁, a second connection conductor 22A₂, and a power feeding conductor 24A. The lower surface conductor 40 is a sheet metal in which the first conductor 10A, the first connection conductor 20A₁, the first connection conductor 20A₂, the second connection conductor 22A₁, the second connection conductor 22A₂, and the power feeding conductor 24 are integrally formed.

The first connection conductor 20A₁ and the first connection conductor 20A₂ are bent toward the X axis direction so as to be parallel to the Z axis direction, and thus the first conductor 10A and a second conductor (not illustrated) are connected.

The second connection conductor 22A₁, the second connection conductor 22A₂, and the power feeding conductor 24A are bent toward the −X axis direction so as to be parallel to the Z axis direction, and thus the first conductor 10A and a fourth conductor (not illustrated) are connected.

The first conductor 10A, the first connection conductor 20A₁, the first connection conductor 20A₂, the second connection conductor 22A₁, the second connection conductor 22A₂, and the power feeding conductor 24A are integrated as illustrated in FIG. 26, and thus the antenna 2A illustrated in FIG. 22 can be easily manufactured. The manufacturing cost of the antenna 2A can be suppressed.

### Other Embodiments

The antenna 2 according to the first embodiment and the antenna 2A according to the second embodiment may be mounted at various structures. Examples of the structures include a container and a pallet used for transportation of various articles. In this case, the antenna 2 or the antenna 2A transmits and receives various types of information related to the articles accommodated in the container to and from a server apparatus or the like. Examples of the structures may include a delivery box accommodating a delivery item.

The embodiments of the present invention have been described above, but the present invention is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1 Wireless communication apparatus
2 Antenna
3 Communication unit
4 Metal member
5 Feeding line
10 First conductor
12 Second conductor
14 Third conductor
16 Fourth conductor
20 First connection conductor
22 Second connection conductor
24 Power feeding conductor
26 Housing
30 Memory
32 Controller
34 Sensor
36 Battery
40 Lower surface conductor

1. A wireless communication apparatus comprising:
an antenna; and
a communication unit disposed inside the antenna and configured to perform wireless communication with an external apparatus via the antenna, wherein
the antenna comprises:
a first conductor expanding in a first plane direction;
a second conductor facing a first end portion, in a first direction, of the first conductor, coupled to the first conductor, and expanding in the first plane direction;
a third conductor facing a second end portion, in the first direction, of the first conductor, coupled to the first conductor, and expanding in the first plane direction, the second conductor and the third conductor being aligned in the first direction;
at least one fourth conductor between the second conductor and the third conductor in the first direction, the at least one fourth conductor being located apart from the second conductor and the third conductor, and expanding in the first plane direction;
a first connection conductor comprising one end connected to the first conductor and the other end connected to the second conductor;
a second connection conductor comprising one end connected to the first conductor and the other end connected to the third conductor; and
a power feeding conductor comprising one end connected to a feeding point and the other end connected to a conductor facing the feeding point among the first conductor, the second conductor, the third conductor, and the at least one fourth conductor, and
the communication unit is disposed inside the antenna at a position where a magnetic field strength is relatively high.

2. The wireless communication apparatus according to claim 1, wherein
the communication unit is disposed at the first conductor in a vicinity of the first connection conductor or the second connection conductor.

3. The wireless communication apparatus according to claim 2, wherein
the communication unit is disposed at the first conductor in a vicinity of one of the first connection conductor and the second connection conductor that is farther from the feeding point.

4. The wireless communication apparatus according to claim 2, wherein
the communication unit is disposed at the first conductor in a vicinity of one of the first connection conductor and the second connection conductor that is closer to the feeding point.

5. The wireless communication apparatus according to claim 1, wherein
the communication unit is disposed at the second conductor or the third conductor in a vicinity of the first connection conductor or the second connection conductor.

6. The wireless communication apparatus according to claim 5, wherein
the communication unit is disposed at the second conductor or the third conductor in a vicinity of one of the first connection conductor or the second connection conductor that is closer to the feeding point.

7. The wireless communication apparatus according to claim 1, wherein
a length of the antenna in a second direction orthogonal to the first direction in the first plane direction is shorter than a length of the antenna in the first direction.

8. The wireless communication apparatus according to claim 1, wherein
the first conductor, the first connection conductor, the second connection conductor, and the power feeding conductor are made of a single-piece metal member.

9. The wireless communication apparatus according to claim 1, wherein
the antenna is mounted at a conductive article on a side on which the first conductor is provided.

10. A structure comprising the wireless communication apparatus according to claim 1.
